(19) United States
(12) Patent Application Publication
(10) Pub. No.: US 2022/0138651 A1
(43) Pub. Date: May 5, 2022

(54) GENERATION OF RECOMMENDED ACTIONS BASED ON STRENGTH AND DIVERSITY OF COLLABORATION IN A USER NETWORK

(71) Applicant: Microsoft Technology Licensing, LLC, Redmond, WA (US)

(72) Inventors: Sanjay Hemmige RAMASWAMY, Redmond, WA (US); Jagadeesh Virupaksha HULIYAR, Redmond, WA (US); Vindana MADHUWANTHA, Bothell, WA (US); Sai Sumana PAGIDIPALLI, Hyderabad (IL); Neha CHOUDHARY, Seattle, WA (US)

(21) Appl. No.: 17/086,251

(22) Filed: Oct. 30, 2020

(51) Int. Cl. G06Q 10/06

(52) U.S. Cl. CPC G06Q 10/06311; G06Q 10/06393

(57) ABSTRACT

The disclosure herein describes improving collaboration between users in a user network based on collaboration strength and collaboration diversity. Collaboration data associated with collaboration activity between a user network is collected. Based on the collaboration data, collaboration ties of the user accounts are identified, wherein each collaboration tie is associated with a source user account and a target user account. For each collaboration tie, a tie strength score and a tie diversity score are determined based on the collaboration data. Each collaboration tie is then classified as a strong tie or a weak tie based on a tie strength threshold and as a diverse tie or a nondiverse tie based on a tie diversity threshold. Based on analysis of the classifications of the collaboration ties, a recommended action is generated and provided via a collaboration interface, whereby the collaboration interface enables collaboration of the user network to be improved.

### BACKGROUND

Many modern companies attempt to measure and evaluate the networks of their employees using metrics such as network size (e.g., the number of other people to whom a person has connections) and network breadth (e.g., the number organizations outside of their own with which a person has meaningful interactions). These metrics have been generally used to understand how strong or diverse an individual person's network is. However, these metrics are flawed proxies for understanding how strong or diverse a person's network truly is. Having a large or small network, or broad or narrow network, is not necessarily an indication of either strength or diversity of that network. Both exemplary measures are quantitative and are not influenced by other qualitative characteristics of an individual's networks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for improving collaboration between users in a user network based on collaboration strength and collaboration diversity is described. Collaboration data associated with collaboration activity between a plurality of users in the user network is collected. Based on the collaboration data, collaboration ties of the plurality of users are identified, wherein each collaboration tie is associated with a source user and a target user and, for each pair of users between which collaboration ties are identified, a first collaboration tie from a first user of the pair as a source user to a second user of the pair as a target user is identified and a second collaboration tie from the second user as source user to the first user as a target user is identified. For each collaboration tie, a tie strength score and a tie diversity score are determined based on the collaboration data. Each collaboration tie is then classified based on a tie strength threshold and on a tie diversity threshold. Based on analysis of the classifications of the collaboration ties, a recommended action is generated and provided via a collaboration interface, whereby the collaboration interface enables collaboration strength or collaboration diversity of the user network to be improved.

### BRIEF DESCRIPTION OF THE DRAWINGS

The present description will be better understood from the following detailed description read in light of the accompanying drawings, wherein:

FIG. 1 is a block diagram illustrating a system configured for classifying collaboration ties between users in a user network and providing recommendations for enhancing the strength and/or diversity of the collaboration ties in the user network based on the classified ties according to an embodiment;

FIG. 2 is a flowchart illustrating a computerized method for generating and providing recommended actions based on strength and diversity of collaboration in a user network according to an embodiment;

FIG. 3A is a flowchart illustrating a computerized method for determining a tie strength score of a collaboration tie from a source user account to a target user account according to an embodiment;

FIG. 3B is a flowchart illustrating a computerized method for determining a tie diversity score of a collaboration tie from a source user account to a target user account according to an embodiment;

FIG. 4 is a flowchart illustrating a computerized method for defining a collaboration tie threshold based on a model trained using collaboration data according to an embodiment;

FIGS. 5A-B are diagrams illustrating exemplary graphical user interfaces (GUIs) for displaying collaboration characteristics and recommended actions according to an embodiment; and

FIG. 6 illustrates a computing apparatus according to an embodiment as a functional block diagram.

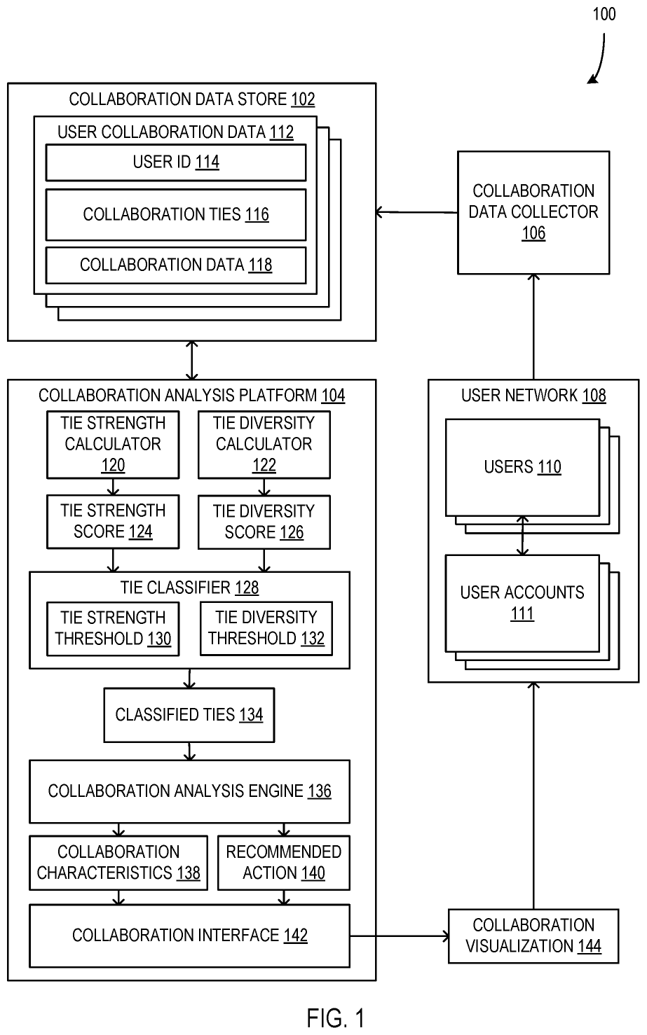

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for classifying collaborations between users of a user network based on strength and diversity and providing recommended actions based on those classifications that are focused on improving the strength and diversity of future collaboration in the user network. Collaboration data (e.g., data indicative of users collaborating with each other via email, meetings, phone conversations, voice chat, shared documents, or the like) associated with collaboration activity between users in the user network is collected and based on the collaboration data, collaboration ties of the users are identified. Each collaboration tie is associated with a source user and a target user and has a direction from the source user to the target user. Further, for each pair of users between which collaboration ties are identified, a first collaboration tie from a first user of the pair as a source user to a second user of the pair as a target user is identified and a second collaboration tie from the second user as source user to the first user as a target user is identified. For each collaboration tie, a tie strength score and a tie diversity score are determined based on the collaboration data. Each collaboration tie is then classified based on a tie strength threshold and on a tie diversity threshold. Based on analysis of the classifications of the collaboration ties, a recommended action is generated and provided via a collaboration interface, whereby the collaboration interface enables collaboration strength or collaboration diversity of the user network to be improved.

Accurately evaluating qualities of a person's network and/or larger or combined networks of people within organizations and accounting for qualitative characteristics of such networks may provide significantly more accurate and actionable information for the organizations but it also presents substantial challenges for the organizations. The disclosure addresses such challenges by enabling organizations to account for qualitative measures of collaboration ties between users of their networks in order to take actions to improve the strength and diversity of the connections within those networks. Beyond mere network size and breadth measures, the disclosure enables the determination of tie strength scores and tie diversity scores based on a variety of other measures of collaboration activity between users, including consideration of direct collaboration between users and indirect collaboration by users with common networks of other users, consideration and weighting of a variety of types of collaboration, and the like. Further, the disclosure operates in an unconventional manner by enabling these many different factors to be combined into strength and diversity scores and for the associated collaboration ties to be classified based on defined thresholds, providing simplified evaluation of collaboration at the most granular level of individual collaboration ties. The disclosure is flexible, representing collaboration activity between a pair of users as two different collaboration ties in opposite directions, which enables recognition of differences in strength and diversity of each connection from the perspective of both users. Additionally, the disclosure describes the definition of strength and diversity thresholds using models that learn to define thresholds based on real data sets, such that the definition of the thresholds being used may be dynamic and improve over time. The disclosed systems and methods provide recommended actions that can be used to improve strength and diversity of connections in an efficient way and enable users to configure what types of recommended actions and associated characteristics are received, including a wide variety of types of collaboration information and at flexible levels of granularity, from the individual user level to the general user network level.

The disclosure provides advantageous effects by generating accurate, relevant recommendations that enable users to enhance the strength and diversity of collaboration in the user network based on the described analysis of qualitative attributes of collaboration. Further, the disclosure enables the improvement of such analyses through flexible methods of calculating tie strength and diversity scores and model-based definition of tie strength and diversity thresholds. Additionally, the disclosure collects collaboration data from a wide variety of different collaboration platforms or applications, further improving the breadth and depth of the collaboration data analysis and enabling the generation of highly targeted, granular recommended actions for enhancing collaboration between users and throughout a user network.

In some examples, a technical problem addressed by the disclosure may include that current communication/collaboration systems (e.g., email systems, document sharing systems, voice chat/electronic chat systems, and/or system that combine multiple methods of collaboration) are under-utilized or used inefficiently by users of an organization. The disclosure addresses such a problem by analyzing the collaboration between the users of the organization and providing recommendations of actions to users of the organization on a per-user-account basis to improve their collaboration with other users (e.g., improve the strength and diversity of the users' connections with each other).

FIG. 1 is a block diagram illustrating a system 100 configured for classifying collaboration ties 116 between users 110 in a user network 108 and providing recommended actions 140 for enhancing the strength and/or diversity of the collaboration ties 116 in the user network 108 based on the classified ties 134 according to an embodiment. The system 100 includes a collaboration data store 102 that stores user collaboration data 112, a collaboration analysis platform 104 that uses the stored user collaboration data 112 to classify collaboration ties, analyze those ties, and generate collaboration characteristics 138 and recommended actions 140, and a collaboration data collector 106 configured to collect collaboration data from users 110 using associated user accounts 111 of a user network 108.

In some examples, the components of system 100, including the collaboration data store 102, the collaboration analysis platform 104, and the collaboration data collector 106, stored on and/or executed on one or more computing devices. For instance, in some examples, the collaboration data store 102, collaboration analysis platform 104, and collaboration data collector 106 occupy and/or are executed on a computing device. Alternatively, or additionally, the collaboration data store 102 may be stored on one computing device while the collaboration analysis platform 104 and/or the collaboration data collector 106 are stored on and executed on other computing devices. Further, in some examples, the collaboration data store 102, the collaboration analysis platform 104, and/or the collaboration data collector 106 are stored on and/or executed on a set of distributed computing devices (e.g., computing devices arranged and connected in a “cloud” according to cloud computing techniques). In examples where the data store 102, the platform 104, and the collector 106 are stored on and/or executed on separate computing devices, those separate computing devices may be configured to communicate with each other using one or more network connections over one or more networks, such as intranets, the Internet, or the like. It should be understood that, in other examples, the components of system 100 may be arranged in other ways using differently organized computing systems without departing from the description.

The collaboration data store 102 includes hardware, firmware, and/or software configured to store user collaboration data 112 and/or other associated data that may be collected by the user collaboration data collector 106 and used by the collaboration analysis platform 104. In some examples, the collaboration data store 102 is configured as a database, but alternative configurations for storage of the user collaboration data 112 may be used without departing from the description.

The collaboration data collector 106 includes hardware, firmware, and/or software configured to collect the user collaboration data 112 and/or other associated data from the users 110 and associated user accounts 111 of the user network 108 and provide the collected data to the collaboration data store 102 for storage. In some examples, the collaboration data collector 106 is configured to monitor and/or track collaboration activities of the users 110 based on technology and/or software applications used by those users 110 for collaboration (e.g., collaboration activities of a user 110 may be tracked based on tracking actions taken by a user account 111 of the user network 108 with which the user 110 is associated). For instance, the collaboration data collector 106 may be configured to collect collaboration data based on emails, meetings, phone calls, voice and/or video chats, instant messaging, and/or shared documents based on communicating with software and/or other technology that enables those methods of collaboration, all of which may be associated with a user account 111 of a user 110 in some examples. For instance, in some examples, the collaboration data collector 106 communicates with an office software platform used by the users 110 through users accounts 111 of the user network 108 to collect user collaboration data 112 based on the users' interactions.

In some examples, the user accounts 111 of the users 110 represent and define the identities of the users 110 within the user network 108 and the user accounts 111 are the primary way that the system 100 generally collects and analyzes collaboration data of users 110 as described herein. It should be understood that collaboration between a first user and a second user implies that the first user is using a first user account to interact with a second user account of the second user (e.g., if the users are collaborating over email, the first user uses the first user account which is associated with an email address to send email to the second user account which is associated with another email address, and both users are enabled to read and send emails via the respective user accounts and associated email addresses). When a collaboration tie is described as being between a source user and a target user, in many examples, it should be understood that the collaboration activity of the tie for which the system 100 has collaboration data 118 is collaboration activity between the source user's user account 111 and the target user's user account 111.

The user collaboration data 112 includes sets of data for each user 110 and associated user account 111 on the user network 108. The user collaboration data 112 of a user 110 includes a user identifier (ID) 114 of the user's user account 111, collaboration ties 116 to other user accounts 111 of the user network 108, and collaboration data 118 associated with collaboration activity by the user 110 via the associated user account 111. Collaboration activity between users may include any actions taken by users to communicate, interact, or otherwise work together on a task, project, or otherwise work toward a common goal. For instance, collaboration activity may include users exchanging emails, users scheduling meetings, users speaking to each other on phone calls or voice chats, users communicating via video meeting software or instant messaging, users collaborating using shared electronic documents in cloud storage, etc. In other examples, other types of collaboration activity may also be used without departing from the description. Further, in some examples, all of the tracked collaboration activity may be done in association with the users' user accounts 111 as described herein. The user ID 114 of the user's user account 111 is a unique or pseudo-unique identifier that may be used to link a particular user 110 and user account 111 to the associated user collaboration data 112. Further, a user ID 114 of a user account 111 may be used to define collaboration ties 116 to the identified user account 111 from other user accounts in the user network 108 (e.g., a collaboration tie 116 may include user IDs 114 of the source user account and the target user account of the collaboration tie 116). The collaboration ties 116 include data that describes other users and associated user accounts with which the user 110 has collaborated via the associated user account 111. For instance, a collaboration tie 116 may include a collaboration tie ID that uniquely identifies the tie and a user ID associated with the user account with which the user account 111 collaborated to form the collaboration tie 116. Further, a collaboration tie 116 may include data that indicates scores, categories, and/or other classifications of the tie 116 that may be determined by the collaboration analysis platform 104 as described below. The collaboration data 118 includes data that defines or describes attributes of the collaboration activities performed by the user 110 via the user account 111. For instance, the collaboration data 118 may include an entry for each instance of collaboration performed by the user of the user account 111. Each entry may include data that indicates which user or users were involved in the collaboration, what type of collaboration was used, whether the collaboration is associated with other collaboration instances (e.g., an email that is part of a chain of multiple emails), and/or other collaboration attributes. The collaboration data 118 may further include data describing each collaboration tie 116, such as quantity of interactions associated with a tie, duration of interactions associated with the tie, types of interactions associated with the tie, patterns of interactions over time, or the like.

In some examples, a collaboration tie 116 from a first user account to a second user account is separate from a collaboration tie 116 from the second user account to the first user account. Both ties may share some collaboration data 118, but, in some cases, the collaboration tie from the first user account to the second user account may have different scores and/or different classifications than the collaboration tie from the second user account to the first user account. For instance, if a first user and a second user collaborate via a chain of emails and instant messaging, their collaboration ties to each other may be associated with similar collaboration data values, but they may not be identical. This aspect of collaboration ties 116 is described in greater detail below with respect to the calculation of strength and diversity scores.

The collaboration analysis platform 104 includes hardware, firmware, and/or software configured to obtain user collaboration data 112 from the collaboration data store 102, analyze the data 112 to score and classify collaboration ties 116, and generate collaboration characteristics 138 and recommended actions 140 for individual users 110, groups of users, and/or the entire user network 108 based on users' associations with user accounts 111. The collaboration analysis platform 104 includes a tie strength calculator 120 configured for calculating or otherwise determining tie strength scores 124 for collaboration ties 116 and a tie diversity calculator 122 configured for calculating or otherwise determining tie diversity scores 126 for collaboration ties 116. In some examples, a tie strength score 124 and a tie diversity score 126 is determined for each collaboration tie 116 of each user account 111.

Determination of the tie strength score 124 for a collaboration tie 116 may be based on the quantity of collaboration instances between the source user (e.g., the user with which the collaboration tie 116 is directly associated) and the target user (e.g., the user with which the source user collaborates to form and/or contribute to the collaboration tie) and/or the duration of collaboration between the source user and target user. “Strong” ties (e.g., collaboration ties 116 with relatively high tie strength scores 124) may be desirable for a user network 108 as they may help build trust, commonality of thought process, commonality of goal, etc. between the source user and target user. Such positive effects may also be seen by other users who are also collected to the users of such a strong tie. However, such strong ties may be difficult to maintain and, in some cases, strong ties may not provide a user with new or diverse information since the associated users tend to collaborate with each other so consistently and/or frequently.

In some examples, the determination of the tie strength score 124 is based on a duration of time spent by the source user and the target user collaborating together, a duration of time spent by the source user collaborating with users in a shared sub-network of other users (e.g., users other than the source user and target user with whom both the source user and the target user have collaboration ties), and a duration of time spent by the target user collaborating with users in the shared sub-network of other users. Such a determination may be made using the following formula:

$$Tie Strength Score ( A \to B ) = \sqrt[3]{( \begin{matrix}\begin{matrix}CTS ( A \to B ) * \\ CTS ( A \to ( AN ⋂ BN ) ) *\end{matrix} \\ CTS ( B \to ( AN ⋂ BN ) )\end{matrix}}$$

In this formula, the tie strength score 124 of a collaboration tie 116 of a user A to a user B is determined. The function CTS(A→B) is equal to the collaboration time spent by user A with user B, the function CTS(A→(AN∩BN)) is equal to the collaboration time spent by user A with the sub-network of users to which both A and B have collaboration ties, and the function CTS(B→(AN∩BN)) is equal to the collaboration time spent by user B with the sub-network of users to which both A and B have collaboration ties. In this way, in addition to taking into account the direct collaboration between user A and user B, the tie strength score 124 is also based on the collaboration of the users A and B with a common sub-network of users. The tie strength score 124 thus may reflect relatively high strength scores for a collaboration tie if the users A and B had little direct collaboration but high levels of collaboration with the common sub-network of users.

The inclusion of common network collaboration data for determining the tie strength scores 124 and the tie diversity scores 126 (described below) may provide some advantages over only considering direct collaboration between the users with which the collaboration tie 116 is associated. For instance, using only direct collaboration data between two users when deciding how to classify the collaboration tie can be lossy and the influence of each user's common, overlapping sub-network of connected users and each user's diverse, non-overlapping sub-network of connected users may be lost in such a determination. For instance, if a user A has a lot of collaboration with a user B, the collaboration tie may be determined to be strong, but direct collaboration does not provide an indication of how diverse the collaboration tie is. However, if it is determined that user B collaborates with many other users with whom user A has no direct connection, the collaboration tie may be considered diverse as well as strong. In another example, if a user A has little direct collaboration with user B, based only on direct collaboration data, it may be determined that the collaboration between users A and B is weak. However, if users A and B also share a large common sub-network of other users with whom they collaborate frequently, the collaboration tie between users A and B may be considered strong.

Determination of the tie diversity score 126 for a collaboration tie 116 may be based on the quantity of collaboration instances between the source user and/or the duration of collaboration between the source user and target user as well as collaboration quantity and duration of the target user with users outside of the common sub-network of users shared by the source and target users. “Diverse” ties (e.g., collaboration ties 116 with relatively high tie diversity scores 126) may be desirable for a user network 108 as they may enable users to obtain access to new and/or diverse information or ideas from other users in the user network 108. Diverse ties may be easier to maintain and further enable the dissemination of diverse and/or new information throughout the user network 108.

In some examples, the determination of the tie diversity score 126 is based on a duration of time spent by the target user collaborating with the source user, a duration of time spent by the target user collaborating with users generally, and a duration of time spent by the target user collaborating with users in the shared sub-network of other users. Such a determination may be made using the following formula:

Tie Diversity Score(A→B)=CTS(B)−CTS(B→(AN∩BN))−CTS(B→A)

In this formula, the tie diversity score 126 of a collaboration tie 116 of a user A to a user B is determined. The function CTS(B) is equal to the collaboration time spent by user B with all other users, the function CTS(B→(AN∩BN)) is equal to the collaboration time spent by user B with the sub-network of users to which both A and B have collaboration ties, and the function CTS(B→A) is equal to the collaboration time spent by user B with user A specifically. The formula is used to determine the degree to which the user B collaborates with other users outside of user A and the common sub-network of users with which both user A and user B have collaboration ties. In this way, the tie diversity score 126 is based on the collaboration of the target user B with diverse users with which user A has no direct connection, indicating a degree to which user B has access to new or diverse information for which user A may be able to leverage the collaboration tie 116 with user B. Importantly, a collaboration tie from user A to user B may have different strength and/or diversity scores than the collaboration tie from user B to user A, depending on how those scores are calculated. For instance, if user B has a wide range of collaborations with many different users to which user A has no direct connection, the collaboration tie from user A to user B may have a relatively high diversity score, representing that user B may be an important source of new, diverse ideas or information for user A, while if user A has few collaborations with users to which user B has no direct connection, the collaboration tie from user B to user A may have a relatively low diversity score, representing that user A may be less useful to user B as a source for new, diverse ideas or information.

Further, in some examples, qualities and/or attributes of collaboration instances may be accounted for when determining tie strength and diversity scores. In addition to or instead of using collaboration time spent as in the above examples, other attributes of the collaboration data associated with a collaboration tie may be quantified and weighted for use in determining associated scores, such as the type and/or quantity of instances of collaboration. For instance, an instance of collaboration via a video chat program may be weighted at a first value while an instance of collaboration via email may be weighted at a second value. Such weights may also be applied to a measure of each collaboration instance, such as duration of the collaboration. Other measures for collaboration may also be used (e.g., for email collaboration, which may not have measurable duration, quantity of emails in a chain of emails, inclusion of attached documents, and/or length of email messages may be used as measures to apply weights to email collaborations).

Additionally, or alternatively, other aspects of collaboration data may be used to apply weights to or otherwise evaluate collaboration instances, such as natural language processing (NLP) being applied to text data associated with collaboration (e.g., email text, chat text, video chat or phone call transcription text). For instance, NLP models (e.g., Bidirectional Encoder Representations from Transformers (BERT) models, Embeddings from Language Models (ELMo) models) may be applied to text data associated with collaboration instances to determine or identify contextual details of the collaboration instances and to use those contextual details to apply weights based on those contextual details (e.g., by evaluating each collaboration instance's importance or value regarding the strength and/or diversity of the associated collaboration tie(s)). As an example, identified context details of a collaboration instance that indicate the collaboration between users includes primarily communications about a particular task or other job-based topic and the communications include technical details applicable to the task may result in the collaboration instance being assigned a relatively higher weight than another collaboration instance that includes context details that indicate the communication was primarily off-topic.

Weighted values of various collaboration instances associated with a collaboration tie may be combined to arrive at a tie strength score and/or a tie diversity score for the collaboration tie (e.g., a number of email collaborations with an email weight factor of 0.4 applied, a number of meeting collaborations with a meeting weight factor of 0.8 applied, and a number of shared electronic document collaborations with a shared document weight factor of 0.7 applied are combined to arrive at a tie strength score for the associated collaboration tie). Other factors may also affect the weighting of collaboration data, such as weighting one-to-one email exchanges higher than large group email chains (indicating that one-to-one email exchanges represent higher tie strength than large group email chains), without departing from the description herein. It should be understood that such quantifying and/or weighting attributes of collaboration instances may be used in combination with the above-described use of collaboration data from direct collaboration and collaboration data from collaboration with common sub-networks of users (e.g., the functions for quantifying and/or weighting attributes of collaboration instances may replace or be included in the “CTS” functions of the above formulas).

In some examples, determining scores associated with collaboration ties may include accounting for indicators of effectiveness of collaboration instances. Collaboration effectiveness indicators may be identified or determined based on collaboration instances or patterns that are effective and bidirectional (e.g., both users of a collaboration tie are equally invested in the collaboration tie). A collaboration tie may not be effective if the investment of users in the collaboration tie is one-sided (e.g., one user is significantly more invested in the collaboration tie than the other user). Collaboration effectiveness indicators may be especially important for evaluating asynchronous communication media such as email (e.g., collaboration effectiveness of email may be monitored based on indicators associated with emails being sent and with emails being read). Alternatively, or additionally, an effective collaboration score for email communications may be determined using the following formula.

$$Effective Email Collaboration Score ( A \to B ) = 1 - \{ \frac{\vert \begin{matrix}Emails Sent ( A \to B ) - \\ Emails Sent ( B \to A )\end{matrix} \vert}{\begin{matrix}Emails Sent ( A \to B ) + \\ Emails Sent ( B \to A )\end{matrix}} \}$$

In the above formula, the difference in emails sent from user A to user B and emails sent from user B to user A is determined as a fraction of total emails exchanged between the two users and that value is subtracted from one to determine an effective email collaboration score of the collaboration tie from user A to user B. Using this formula, if the difference between emails from user A to user B and emails from user B to user A is large, the determined fraction value approaches one, which causes the ultimate score to approach zero (e.g., subtracting a larger fraction from one is closer to zero than subtracting a smaller fraction from one). Alternatively, if the difference in emails sent between the two users is small, meaning that both users are close to equally invested in the email collaboration, the determined fraction approaches zero, such that the ultimate score approaches one. Such an Effective Email Collaboration Score may be applied to a value that measures the email collaboration, such as a duration of email collaboration time (e.g., multiplying a duration value by the Effective Email Collaboration Score) to ensure that both the quantity and quality of collaboration is accounted for in the ultimate tie strength score and tie diversity score determinations.

The tie classifier 128 includes hardware, firmware, and/or software configured to classify each collaboration tie 116 of each user 110 based on tie strength thresholds 130 and tie diversity thresholds 132, such that classified ties 134 are produced. In some examples, the tie strength threshold 130 and/or tie diversity threshold 132 are values that are defined based on a known range of possible tie strength scores 124 and tie diversity scores 126, respectively. In such examples, when the tie strength score 124 and tie diversity score 126 of a collaboration tie 116 are calculated and provided to the tie classifier 128, the tie classifier 128 compares the tie strength score 124 to the tie strength threshold 130 and the tie diversity score 126 to the tie diversity threshold 132 and classifies the collaboration tie 116 based on those comparisons, such that the collaboration tie 116 becomes a classified tie 134. For instance, if the tie strength score 124 of a collaboration tie 116 is above the tie strength threshold 130 and the tie diversity score 126 is below the tie diversity threshold 132, the collaboration tie 116 may be classified as a strong, nondiverse collaboration tie 134. In such examples, where the possible classifications include strong, weak (e.g., not strong), diverse, and nondiverse, each collaboration tie 116 may be classified as strong and diverse, strong and nondiverse, weak and diverse, or weak and nondiverse.

As described above, collaboration ties 116 between two users via associated user accounts include a tie 116 from the first user to the second user and a tie 116 from the second user to the first user. As a result, both ties 116 between two users may be classified in the same classifications or in different classifications (e.g., a tie from a first user to a second user may be strong and diverse, while a tie from the second user to the first user may be strong and nondiverse).

In other examples, the tie classifier 128 is configured to classify collaboration ties 116 according to more types of categories (e.g., additional categories beyond strength and diversity) and/or more classifications within the categories (e.g., multiple thresholds for a category). For instance, instead of a single tie strength threshold 130 that is used to classify a tie as either strong or weak, the tie classifier 128 may be configured with multiple tie strength thresholds 130 that are used to classify a tie as various levels of tie strength (e.g., a first threshold that classifies a tie as level 1 tie strength, a second threshold that classifies a tie as level 2 strength, and a third threshold that classifies a tie as level 3 strength). Multiple levels of thresholds may also be used with tie diversity thresholds 132 and/or any other categories that may be included.

Additionally, or alternatively, the tie strength thresholds 130 and the tie diversity thresholds 132 may be defined dynamically and may vary based on other attributes of the collaboration tie 116 being classified. For instance, the tie strength threshold 130 may vary based on the role of one or both of the users associated with the collaboration tie 116 (e.g., some roles require less collaboration to be productive and, as a result, the threshold for tie strength is set to a lower value than other roles that may require more collaboration to be productive). Other attributes may be considered for configuring specific thresholds, such as whether both users of a tie 116 are on the same team within the user network 108, whether the relationship between the users of a tie 116 is one of manager-to-subordinate or one of colleague-to-colleague, or the like.

In some examples, tie strength thresholds 130 and/or the tie diversity thresholds 132 are determined using a model or models that learn to define the thresholds such that the classifications made based on the model-defined thresholds lead to an accurate prediction of a property or properties of the user network 108 or other networks. While predicting such a property may not be the goal since it may be directly computed from the collaboration data that is being collected, the property may be used as a ground truth for self-supervision of the models while learning to define the thresholds. In order to train the threshold setting models, a hypothetical scenario where the edge weights in a network are unknown is considered. The edge weights in the scenario correspond to a collaboration time value (or another measure of collaboration between users of the network). Additionally, in the scenario, a system exists that provides indicators of whether a particular tie between users is strong or not to a certain accuracy. This information may be used to estimate or reason about some of the mutual or common network properties between any two given nodes. With this premise, a prediction task is formulated. A tie strength score is a combination of how two nodes have interacted over time as well as the interaction with the common network of users shared by the two node users. Similarly, the tie diversity score represents a node's diversity of information outside of a source node and its common network interaction, as described herein. From these definitions, both scores are indicative of some edge features of the network and should have predictive properties.

For instance, the model may be configured to determine a tie strength threshold 130 by trying a variety of thresholds based on the range of tie strength scores that are known, from the 0^{th} percentile tie strength score to the 99^{th} percentile tie strength score. For each tried threshold value, the threshold value is used to predict a component of the tie strength scores, such as common network strength or mutual network strength of the edges associated with ties known to be strong. The tried threshold value that results in the lowest error in such predictions may be selected as the most optimal threshold for use as a tie strength threshold 130. Such a process may also be used for a model that defines a tie diversity threshold 132 as well. Further, in some examples, the models trained are linear and, as a result, lightweight to train and score, even on large network graphs with dense collaboration tie edges.

The collaboration analysis engine 136 includes hardware, firmware, and/or software configured for receiving classified ties 134 from the tie classifier 128 and generating collaboration characteristics 138 of individual users 110, groups of users 110, and/or the user network 108 in general and generating recommended actions 140 indicating actions to be taken to improve the strength and/or diversity of collaboration ties 116 between users 110 of the user network 108 via associated user accounts 111. In some examples, the generation of collaboration characteristics 138 and/or recommended actions 140 includes comparing tie strength scores 124, tie diversity scores 126, and/or associated classifications of groups of collaboration ties 116 to identify strength and/or diversity-related patterns in the collaboration ties 116 of the user network 108. Further, the collaboration analysis engine 136 may be configured to perform statistical and/or pattern analyses on classifications of collaboration ties 116 throughout the user network 108 and based on changes to those classification over time (e.g., identifying ties 116 that are becoming stronger or weaker over time and associated users, teams of users, or the like). As a result, the collaboration characteristics 138 may include time-based information, such as rates of change in strength or diversity of ties throughout the user network 108.

In some examples, the collaboration characteristics 138 and recommended actions 140 generated by the collaboration analysis engine 136 are associated with network stability evaluation, manager effectiveness, top performer analysis, dormant connection identification and evaluation, team efficiency, team innovation, and/or mentor identification. For instance, network stability within the user network 108 may be evaluated to identify changes in connectivity over time (e.g., in the face of a pandemic that results in many employees of a user network of a company changing how they work, including working from home more often). The evaluation of network stability may include providing time-based trends regarding strong and diverse ties: for example, if strong ties are trending downward, then it might indicate reduced team cohesion levels, inadequate tools to facilitate continued connectivity, and/or possibly employee disengagement. In response to this, recommended actions 140 may be generated that prompt employees to reconnect when their connectivity drops. Additionally, or alternatively, network stability may be evaluated with respect to the addition of new applications for collaboration, such as a platform for sharing documents or a flexible application enabling voice chat, video chat, and other communication methods within one platform. Users may be provided with collaboration characteristics 138 indicating changes to strength and diversity of connections in response to the deployment of the new tools.

Manager effectiveness is a growing area of interest in People Analytics space, across both Organization Analytics and Personal Analytics. Recent research on Manager effectiveness highlights the importance and need for understanding and measuring quality and effectiveness of manager networks. Recent study on manager effectiveness put the focus on a “Connector” manager profile that showcases the most effective managers. In short Connector managers do the following:
Ensure that they have tight-knit connections with their directs (“The Employee Connection”)
Ensure that the team they lead are on peer level where everyone is talking to everyone (“The Team Connection”)
Ensure that they and their team have the right kind of targeted connections outside of the team to broaden the team's horizon, encourage a positive working environment, and boost overall team performance (“The Company Connection”)

Connector managers do not claim to be the know-all; they instead point their employees to the right people in their network, within the team or across the company. Connector managers also do not just pair up their employees with connections, but via a hands-off approach they ensure that these connections serve their employees in the right way. All put together, Connector managers' employee performance is 26% higher, with a 3× likelihood of their employees becoming star performers. With the described strong and diverse ties scores and associated classifications, characterizing a manager's profile vs. Connector manager profile characteristics may be done in a highly customized, contextual, and impactful way. In such examples, the collaboration analysis engine 136 may: measure if the manager is driving “The Employee Connection”, by analyzing whether strong ties exist between the manager and every direct, measure if the manager is driving “The Team Connection”, by analyzing whether sufficient strong and diverse ties exist between every member of the team, and/or measure if the manager is driving the “The Company Connection”, by analyzing whether sufficient diverse and strong ties exist in their network (and their directs' networks).

Additionally, the collaboration characteristics 138 and recommended actions 140 may pertain to top performer analysis of the classified ties 134 and associated scores and data. Some research indicates that top performing employees in companies may excel because of their access to strong and rich networks of contacts within the network of the company. The use of strong and diverse classifications at the individual collaboration tie level, as described herein, enable the collaboration analysis engine 136 to measure engages and diverse connections of each users to other users within the user network and also to analyze such connections across any grain (e.g., such as based on function of the users, level of the users, tenure of the users) rather than being limited to higher-level organization attribute levels or the like.

In some examples, the collaboration analysis engine 136 is configured to analyze the classified ties 134 and associated scores and collaboration data to identify and reevaluate “dormant” connections or ties (e.g., ties which become inactive or less strong over time due to contextual necessity, professional or role changes, time constraints, or even conflicts). The collaboration analysis engine 136 may identify dormant ties to provide recommendations for reconnecting, which may result in a stronger tie that provides a source for new insights. Further, reconnecting tends to be easier and more efficient than forming new ties, so highlighting of ties that have become dormant may provide users with easy starting points for improving their strength and diversity within the user network. The engine 136 may be configured to periodically evaluate a users' networks for dormancy across both strong and diverse ties and based on past and current scores and current context and generate recommended actions 140 that encourage reconnection along dormant ties.

Additionally, in some examples, based on identifying a “dormant” tie (e.g., identifying a negative change in strength of a tie that exceeds a defined dormant tie strength threshold, identifying that the length of time since the last collaboration of the users of the tie exceeds a defined collaboration time threshold), the collaboration analysis engine 136 automatically pushes a reconnection recommendation to the users via their user accounts associated with the tie (e.g., automated emails or messages may be sent to each user prompting them to reconnect). Alternatively, or additionally, the collaboration analysis engine 136 may automatically invite the users associated with a tie to a meeting to simplify the reconnection of those users (e.g., the engine 136 may automatically generate a meeting based on the users' calendars and invite both users of the tie to the generated meeting).

In some examples, the collaboration analysis engine 136 is configured to analyze the classified ties 134 and associated scores and collaboration data to identify teams of users that are predicted to be efficient and/or innovative. A team of users (e.g., users that tend to work on the same or similar projects for an employer) that has strong collaboration ties with each other may be considered a strong team and, if the users external collaboration ties (e.g., ties with users outside of the team) do not substantially overlap, the team may be considered a team with highly diversified connectivity, which may give the team greater access to helpful outside resources. Using tie strength and diversity scores and classifications, the engine 136 may generate collaboration characteristics 138 and associated recommended actions 140 that indicate teams that exhibit such strength and diversity signatures as indicators of the team's predicted efficiency. Alternatively, or additionally, a team with fewer strong internal collaboration ties may indicate that the team of users will have different perspectives. If the team also has highly diversified connectivity to external users, such a team may be predicted to be more effectively innovative.

Additionally, or alternatively, the collaboration analysis engine 136 may be configured to identify mentor-mentee relationships based on the classified ties 134 and associated scores and collaboration data. Further, identification of multiple mentors with diverse backgrounds and connections for a user may indicate that the user can and should take advantage of the diverse learning opportunities offered by the identified mentors. The collaboration characteristics 138 and associated recommended action 140 may include indicators of users that have robust relationships with one or more mentors and suggestions for collaboration ties 116 that a user may form or strengthen to improve their network of potential mentors.

In some examples, the recommended actions 140 generated by the engine 136 may include recommending a user form or strengthen a tie to another user, recommending a user in a team form or strengthen a tie to one or more users in another team, and/or recommending the use of different types of collaboration between users of the network based on the analysis of the engine 136 and/or associated collaboration characteristics 138. In other examples, the types of recommended actions 140 generated by the engine 136 may include more, fewer, or different types of actions without departing from the description.

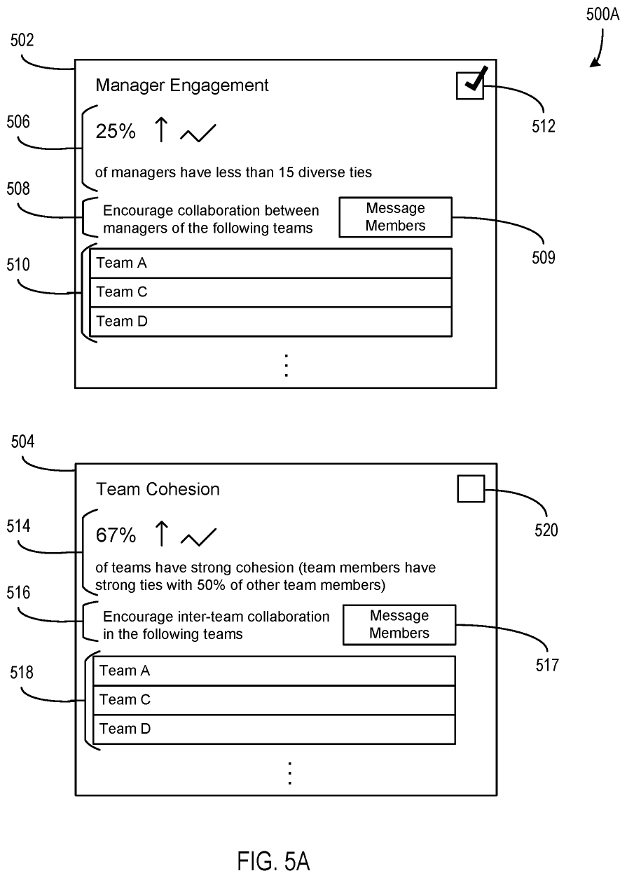

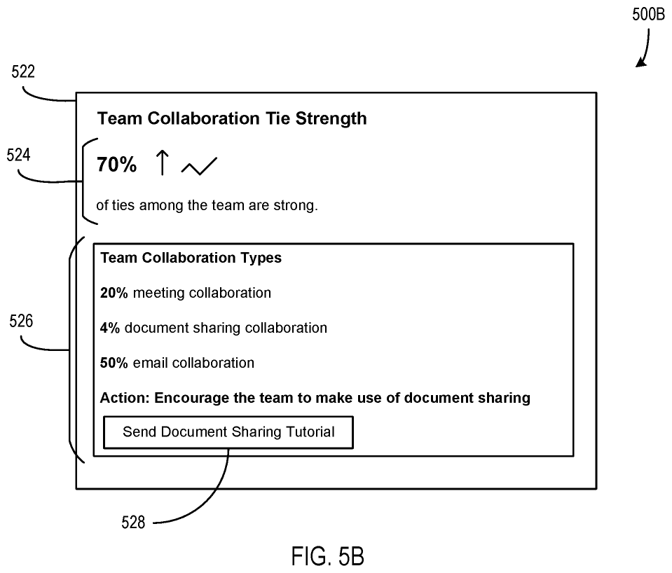

The collaboration interface 142 includes hardware, firmware, and/or software configured for receiving collaboration characteristics 138 and/or recommended actions 140 from the collaboration analysis engine 136 and generating a collaboration visualization 144 for presenting the received collaboration characteristics 138 and/or recommended actions 140. The collaboration visualization 144 may be presented to one or more users 110 of the user network 108 and/or other interested parties. In some examples, the collaboration visualization 144 is automatically presented, displayed, or provided to one or more users 110 of the user network 108 based on the tie strength score 124 and/or tie diversity score 126 falling above or below a defined threshold and/or falling within a defined range. The visualization 144 may include text that presents and/or describes the collaboration data and the analysis thereof, as described herein. Further the visualization 144 may include charts, tables, graphics, or other visual components for presenting aspects of the collaboration data and analysis (e.g., bar charts or pie charts for presenting comparisons of groups of users or statistics). In some examples, users that view the presented collaboration visualization 144 may be enabled to select the types of information to see and/or change what types of information is displayed to users by default. Examples of visualizations 144 are provided below with respect to FIGS. 5A-5B.

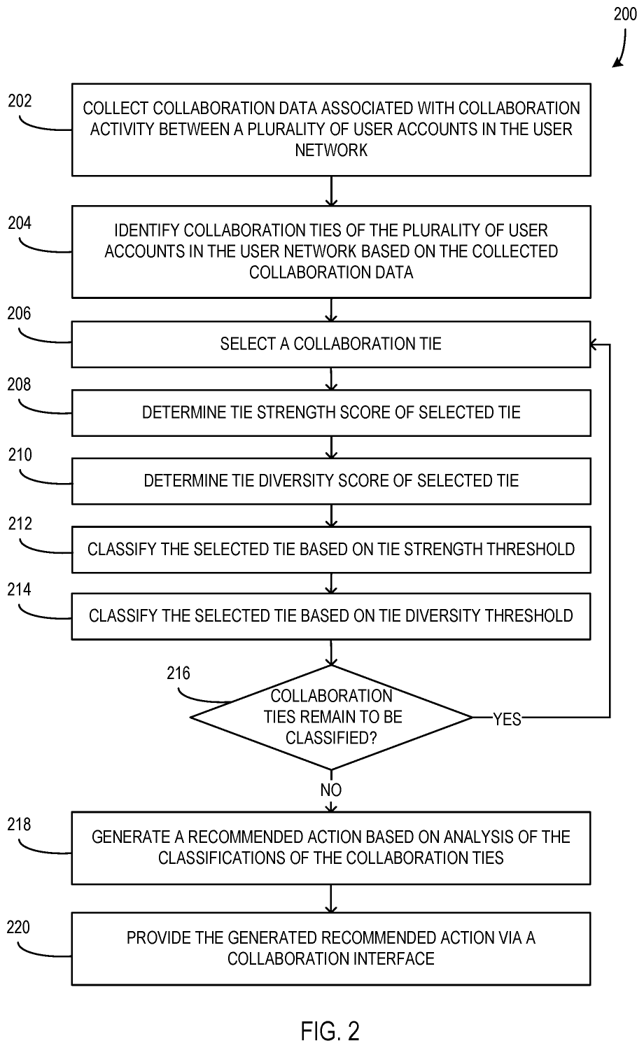

FIG. 2 is a flowchart illustrating a computerized method 200 for generating and providing recommended actions (e.g., recommended action 140) based on strength and diversity of collaboration in a user network (e.g., user network 108) according to an embodiment. In some examples, the method 200 is executed or otherwise performed in a system such as system 100 and/or by one or more components thereof, such as collaboration data store 102, collaboration analysis platform 104, and/or collaboration data collector 106. At 202, collaboration data (e.g., user collaboration data 112) associated with collaboration activity between a plurality of user accounts (e.g., user accounts 111) in a user network (e.g., user network 108) are collected. In some examples, the collaboration data is collected by a collaboration data collector such as collector 106 as described herein. Collection of the collaboration data may include monitoring devices and/or software or interactions between devices and/or software via which users' user accounts collaborate with each other in the user network. Further, the collected data may be provided to a collaboration data store 102 for storage and use by a collaboration analysis platform 104 as described herein.

At 204, collaboration ties (e.g., collaboration ties 116) of the plurality of users of the user network are identified based on the collected collaboration data. In some examples, a collaboration tie from a first user account to a second user account may be identified based on one or more instances of collaboration from the first user account to the second user account being present in the collected collaboration data. A plurality of instances from the first user account to the second user account may be associated with the identified collaboration tie from the first user account to the second user account and used to score and/or classify the collaboration tie as described herein. Further, if back-and-forth collaboration between the first user account and the second user account (e.g., collaboration instance(s) from the first user account to the second user account and collaboration instance(s) from the second user account to the first user account) is present in the collected collaboration data, a first collaboration tie from the first user account to the second user account is identified and a second collaboration tie from the second user account to the first user account is identified, such that there are two collaboration ties between the first user account and the second user account, one tie for each direction of collaboration between the first user account and the second user account.

At 206, a collaboration tie of the identified collaboration ties is selected for processing and, at 208, a tie strength score of the selected tie is determined. In some examples, the tie strength score is determined based on collaboration data associated with collaboration between the source user account of the tie and the target user account of the tie (e.g., one direction or both directions of collaboration: from the source user account to the target user account and/or from the target user account to the source user account). Further, the determination of the tie strength score may be based on collaboration of the source user account with a common set of user accounts (e.g., user accounts with which the source user account and the target user account have collaboration ties) and collaboration of the target user account with the common set of user accounts.

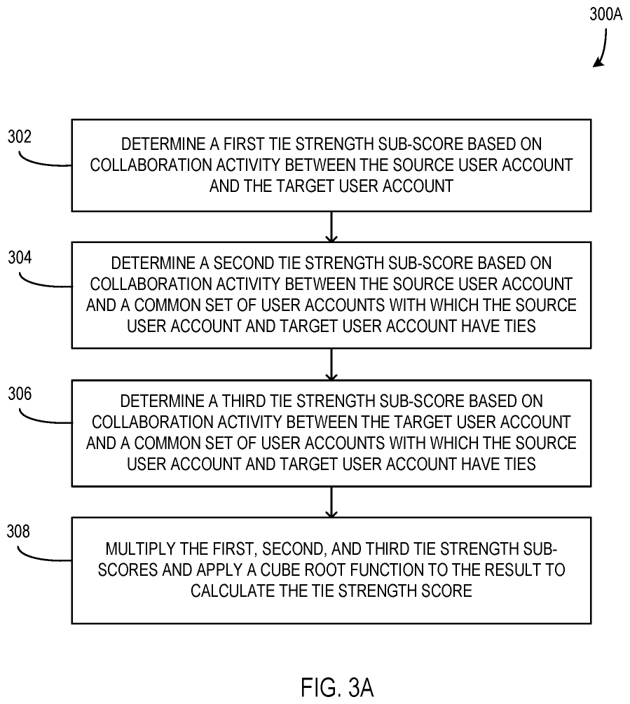

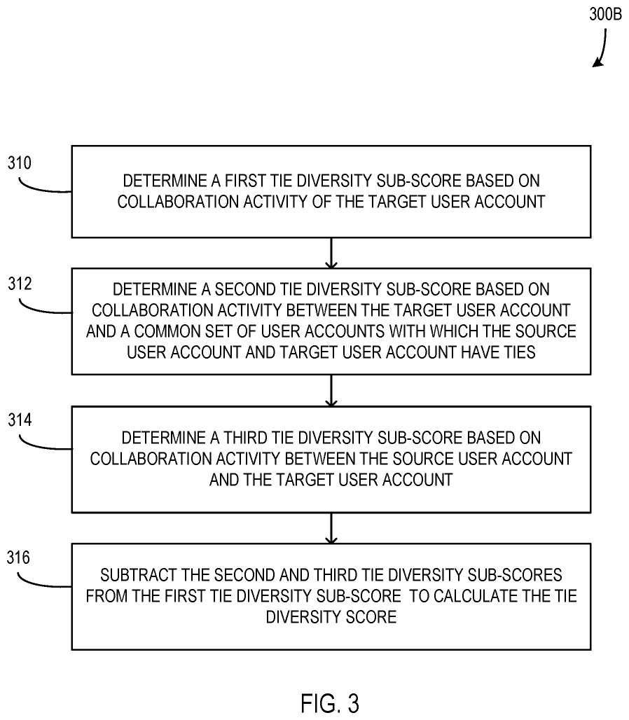

In some examples, FIG. 3A is a flowchart illustrating a computerized method 300A for determining a tie strength score of a collaboration tie (e.g., collaboration ties 116) from a source user account to a target user account according to an embodiment. At 302, a first tie strength sub-score is determined based on collaboration activity between the source user account of the collaboration tie and the target user account of the collaboration tie. The first tie strength sub-score may be based on collaboration in both directions between the source user account and the target user account. Further, the first tie strength sub-score may be based on attributes of the collaboration, such as collaboration duration, quantity of collaboration instances, and/or types of collaboration and the determination of the tie strength sub-score may be based on associated collaboration data values that are aggregated and/or weighted as described herein.

At 304, a second tie strength sub-score is determined based on collaboration activity between the source user account of the tie and the common set of user accounts with which the source user account and target user account have ties. As with the first tie strength sub-score, the second tie strength sub-score may be based on collaboration from the source user account to the common set of user accounts and to the source user account from the common set of user accounts or only on collaboration in one direction from the source user account. Further, as with the first tie strength sub-score, the second tie strength sub-score may be based on one or more attributes of the collaboration as described herein.

At 306, a third tie strength sub-score is determined based on collaboration activity between the target user account and the common set of user accounts. As with the first and second tie strength sub-scores, the third tie strength sub-score may be based on collaboration activity between the target user account and the common set of user accounts in one or both directions of collaboration and it may be based on one or more attributes of the collaboration as described herein.

At 308, the first, second, and third tie strength sub-scores are multiplied, and a cube root function is applied to the result to determine the tie strength score of the collaboration tie. In this way, each of the sub-scores affect the resulting tie strength score. In some examples, weights may be applied to the sub-scores prior to their multiplication to adjust the degree to which each sub-score affects the resulting tie strength score (e.g., the first sub-score may be weighted more heavily than the second and third sub-scores to prioritize the effect of the direct collaboration between the source user account and the target user account over the effect of collaboration with the common set of other user accounts).

Returning to FIG. 2, at 210, a tie diversity score of the selected tie is determined. In some examples, the tie diversity score is determined based on collaboration data associated with collaboration from the target user account of the tie to the source user account of the tie (the diversity of a tie from the source user account to the target user account may be configured to indicate a value of the tie to the source user based on the access to information and ideas from the target user). Further, the determination of the tie diversity score may be based on collaboration of the target user account with a set of user accounts to which the source user account has no collaboration ties and on collaboration of the source user account and the target user account.

In some examples, FIG. 3B is a flowchart illustrating a computerized method 300B for determining a tie diversity score of a collaboration tie (e.g., collaboration ties 116) from a source user account to a target user account according to an embodiment. At 310, a first tie diversity sub-score is determined based on total collaboration of the target user account of the collaboration tie. The first tie diversity sub-score may be based on collaboration in both directions between user accounts and the target user account or in one direction to or from the target user account. Further, the first tie diversity sub-score may be based on attributes of the collaboration, such as collaboration duration, quantity of collaboration instances, and/or types of collaboration and the determination of the tie diversity sub-score may be based on associated collaboration data values that are aggregated and/or weighted as described herein.

At 312, a second tie diversity sub-score is determined based on collaboration activity between the target user account of the tie and the common set of user accounts with which the source user account and target user account have ties. As with the first tie diversity sub-score, the second tie diversity sub-score may be based on collaboration from the target user account to the common set of user accounts and to the target user account from the common set of user accounts or only on collaboration in one direction to or from the target user account. Further, as with the first tie diversity sub-score, the second tie diversity sub-score may be based on one or more attributes of the collaboration as described herein.

At 314, a third tie diversity sub-score is determined based on collaboration activity between the source user account and the target user account. As with the first and second tie diversity sub-scores, the third tie diversity sub-score may be based on collaboration activity between the source user account and the target user account in one or both directions of collaboration and it may be based on one or more attributes of the collaboration as described herein.

At 316, the second and third tie diversity sub-scores are subtracted from the first tie diversity sub-score to calculate the tie diversity score of the collaboration tie. In this way, each of the sub-scores affect the resulting tie diversity score. The tie diversity score reflects the degree to which the target user account of the collaboration tie collaborates with other user accounts of the user network to which the source user account does not have direct collaboration ties, indicating a degree to which the collaboration tie with the target user account provides access to those other user accounts to the source user account. In some examples, weights may be applied to the sub-scores prior to their combination to adjust the degree to which each sub-score affects the resulting tie diversity score.

Returning to FIG. 2, at 212, after the scores of the collaboration tie are determined for the selected collaboration tie, the selected tie is classified based on a tie strength threshold. In some examples, the tie strength score of the selected collaboration tie is compared to the defined tie strength threshold and, if the score exceeds the tie strength threshold, the tie is classified as a strong tie. Alternatively, if the score does not exceed the tie strength threshold, the tie is classified as a weak tie. In other examples, the tie may be classified based on more than two categories, such as classifying the tie according to three or more levels of strength based on multiple tie strength thresholds. Additionally, or alternatively, the classification of the selected tie may be based on one or more attributes of the collaboration data associated with the tie (e.g., the classification may be based on the types of collaboration, quantity of collaboration, and/or duration of collaboration and one or more thresholds associated with those attributes).

At 214, the selected tie is classified based on a tie diversity threshold. In some examples, the tie diversity score of the selected collaboration tie is compared to the defined tie diversity threshold and, if the score exceeds the tie diversity threshold, the tie is classified as a diverse tie. Alternatively, if the score does not exceed the tie diversity threshold, the tie is classified as a nondiverse tie. In other examples, the tie may be classified based on more than two categories, such as classifying the tie according to three or more levels of diversity based on multiple tie diversity thresholds. Additionally, or alternatively, the classification of the selected tie may be based on one or more attributes of the collaboration data associated with the tie (e.g., the classification may be based on the types of collaboration, quantity of collaboration, and/or duration of collaboration and one or more thresholds associated with those attributes).

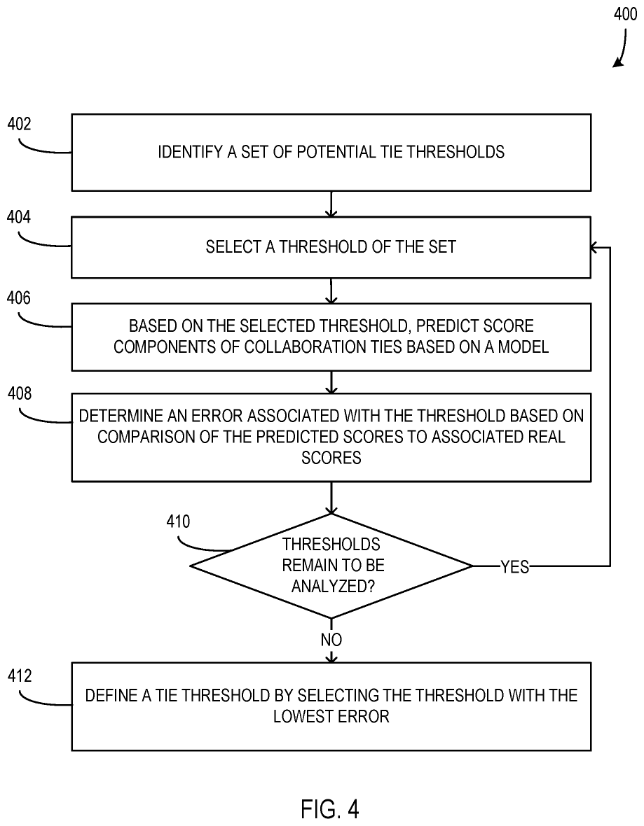

In some examples, it should be understood that the defined tie strength threshold(s) and/or the defined tie diversity threshold(s) may be defined manually and/or using dynamic and/or automatic threshold definition techniques, such as using a model to learn to define the thresholds as described above and with respect to FIG. 4.

If, at 216, collaboration ties remain to be classified, the process returns to 206 to select another collaboration tie that has not been classified. Alternatively, if no collaboration ties remain to be classified, the process proceeds to 218.

At 218, a recommended action is generated based on analysis of the classifications of the collaboration ties. The recommended action may be generated to encourage action to be taken to improve the strength and/or diversity of one or more collaboration ties of the user network. Alternatively, or additionally, the recommended action may encourage the formation of one or more new collaboration ties that may also result in stronger or more diverse collaboration ties associated with the new collaboration ties. The analysis of the classifications may include analyzing the collaboration ties of individual user accounts and comparing those analyses to other user accounts, analyzing the collaboration ties of groups of user accounts, such as teams within the organization of the user network, and comparing those analyses with other user accounts or groups of user accounts, and/or analyzing the collaboration ties of the user network as a whole and comparing those analyses with other user accounts or groups of user accounts. Further, in some examples, when access to collaboration tie analysis of other user networks or organizations is available, the analysis of the classification of the collaboration ties of user accounts, groups of user accounts, or the user network as a whole may be compared to similar analyses of the other user networks or organization (e.g., benchmarks of these analyses may be provided with the recommended action based on these comparisons). The recommended action may be based on the identification of user accounts or groups of user accounts that are outliers with respect to tie strength and/or tie diversity (e.g., user accounts that have lower than average tie strength and/or lower than average tie diversity), the identification of collaboration ties that may be strengthened through the recommended action, the identification of user accounts that may provide diverse ties to a particular user account through formation or strengthening of ties as recommended by the recommended action, or the like. In other examples, more, fewer, or different recommended actions may be generated based on different types of analysis of the classification and/or associated scoring of collaboration ties without departing from the description.

At 220, the generated recommended action is provided via a collaboration interface. In some examples, the generated recommended action is displayed via a GUI to one or more users (e.g., the exemplary GUIs of FIGS. 5A-B). Further, collaboration characteristics may be provided with the recommended action as context information. The provision of the recommended action may be performed automatically (e.g., a notification email sent to a user to recommend strengthening of one or more collaboration ties) and/or based on selections made by a user or associated configurations or settings (e.g., a customized dashboard that provides a user with a selected variety of collaboration characteristics and associated recommended actions on request, where the user's selections may be saved in association with the user's user account).

FIG. 4 is a flowchart illustrating a computerized method 400 for defining a collaboration tie threshold (e.g., tie strength threshold 130, tie diversity threshold 132) based on a model trained using collaboration data (e.g., user collaboration data 112) according to an embodiment. In some examples, the defined collaboration tie threshold that is a result of this method 400 may be used in a system, such as system 100, and/or associated components, such as the tie classifier 128 of the collaboration analysis platform 104. At 402, a set of potential tie thresholds is identified. In some examples, identifying the set of potential tie thresholds includes accessing a data set of associated tie scores (e.g., for potential tie strength thresholds, a data set of tie strength scores is accessed). Based on the range of scores in the accessed data set, potential thresholds may be identified within the range. For instance, each percentile value score of the data set range may be identified as a potential tie threshold (e.g., the 1% percentile score, the 5% percentile score, the 50% percentile score, and/or the 99% percentile score). Alternatively, or additionally, other methods may be used to identify the set of potential tie thresholds (e.g., each unique score value of the range of the accessed data set may be identified as a potential tie threshold).

At 404, a threshold of the set of potential tie thresholds is selected and, at 406, score components of a set of available collaboration ties with associated classifications are predicted based on the selected threshold using a predictive model. For instance, if each collaboration tie of the set of collaboration ties is associated with a score and a classification associated with the threshold, the model is used to predict a score for the collaboration tie based only on the classification and the currently selected threshold.

At 408, errors are determined based on the predicted scores for the collaboration ties and the determined errors are combined and associated with the selected threshold as the error value of that selected threshold. In some examples, combining the multiple errors may include adding all the individual errors together, averaging the individual errors, or some other method without departing from the description.

At 410, if thresholds of the identified set of thresholds remain to be analyzed, the process returns to 404 to select another threshold. Alternatively, if no threshold remains to be analyzed, the process proceeds to 412. At 412, a tie threshold is defined by selecting the threshold from the identified set of potential tie thresholds with the lowest error value. It should be understood that the model may be configured to predict a score and/or component of a score associated with a collaboration tie in a variety of ways without departing from the description.

FIGS. 5A-B are diagrams illustrating exemplary graphical user interfaces (GUIs) 500A and 500B for displaying collaboration characteristics and recommended actions according to an embodiment. In some examples, the GUIs 500A and/or 500B are provided as at least a portion of the collaboration visualization 144 of the system 100 and the GUIs 500A and/or 500B are configured to display collaboration characteristics 138 and/or recommended actions 140 as described herein.

In FIG. 5A, two exemplary visualizations 502 and 505 are illustrated. In some examples, a user at a company may be presented with one or more of the visualizations 502-504 and/or other similar visualizations at one time. The Manager Engagement visualization 502 includes a portion 506 that presents a current collaboration characteristic metric associated with managers of the company, including a direction in which the metric is changing (the up arrow) and/or a graph illustrating the change of the metric (the line graph portion adjacent to the up arrow), as well as text that describes what the metric indicates. The visualization 502 further includes portion 508 including a description of the recommended action and a portion 510 that includes a list of teams at which the recommended action is targeted. Further, the portion 508 includes a “message members” button 509 that, when activated, enables the user of the visualization 502 to message the teams listed in the portion 510 to encourage collaboration according to the recommended action. For instance, activating the message members button 509 may send an automatically generated email or other type of message to the managers of the listed teams of portion 510 that encourages them to reach out to members of other teams to increase their numbers of diverse ties. Additionally, the automated messages may include specific users that are recommended for connection (e.g., users with which diverse ties could easily be formed, such as users that have connections to a lot of other users that the manager receiving the message has no connections to). In other examples, the recommended action may be user specific, rather than team specific, or even generalized for the entire user network. In some examples, the visualizations 502-504 may be presented with checkboxes 512 and 520 or other similar interface components when the viewer is being prompted to select which visualizations they want to see in the future. By checking or otherwise activating the checkbox 512 and not checking or otherwise activating the checkbox 520 as illustrated, the user may select to be presented the visualization 502 in the future and to not be presented the visualization 504 in the future.

The visualization 504 includes corresponding portions to the portions of the visualization 502 as described above. The visualization 504 has a portion 514 that displays information about the collaboration characteristics of the company. In particular, the visualization 504 is directed to a team cohesion characteristic. The visualization 504 has a portion 516 that displays a description of the recommended action associated with improving team cohesion, and it has a portion 518 that includes a list of teams at which the recommended action is targeted. Further, the portion 516 includes a “message members” button 517 that, when activated, enables members of the teams listed in portion 518 to increase collaboration with each other. For instance, upon activating of the message members button 517, members of the listed teams may be sent automatic messages that encourage collaboration with other members of their own teams. Additionally, the automatic messages may include specific members of the team with which the user targeted by the message has relatively weaker ties, enabling the user to focus on strengthening the ties that need it most. Interacting with portion 512 and/or 520 may cause more information about the collaboration of the users within the company, such as other collaboration characteristics or other recommended actions for how to improve the strength and/or diversity of the user network going forward.

FIG. 5B illustrates a GUI 500B including a collaboration visualization 522. The visualization 522 displays or otherwise presents collaboration characteristics and a recommended action associated with a “Team Collaboration Tie Strength” category. The portion 524 presents data describing performance of the team with respect to a particular metric: the percentage of collaboration ties within the team that are considered strong. In this case, the percentage is 70%. Further, as described above, the portion 526 displays additional characteristics of the collaboration of the team, including a breakdown of major types of collaboration by percentage. In this case, the team has 20% meeting collaborations, 50% email collaborations, and only 4% document sharing collaborations. These percentages may be based on duration, quantity of collaboration instances, or some combination thereof. The portion 526 further includes a recommended action to “encourage the team to make use of document sharing”. The collaboration characteristics displayed in the portion 526 relate closely to the topic of the recommended action, which is improving the rate at which people collaborate by document sharing. In such an example, document sharing may be considered to be more effective and/or productive than the other types of collaboration listed, and so, the recommended action may be generated to encourage users of the team to improve that characteristic of the collaboration. Additionally, the portion 526 includes a “Send Document Sharing Tutorial” button 528 that, when activated, may send an automated email or other type of message to the members of the team that includes document sharing tutorial information or otherwise a link or other means to access a document sharing tutorial. The button 528 may be specifically generated based on the recommended action having to do with document sharing specifically, and, in other examples, other types of tutorial-based buttons or the like may be shared based on the recommended action being associated with other topics. In addition to providing users that receive the message with access to a document sharing tutorial, in some examples, the system may identify past collaborations between users on the team that did make use of document sharing but that may have been improved through using document sharing (e.g., the system may identify an email chain with many back-and-forth messages that include attached documents with the same or similar names, implying that the users involved in the chain are repeatedly sending different versions of the same document to each other).

### Exemplary Operating Environment

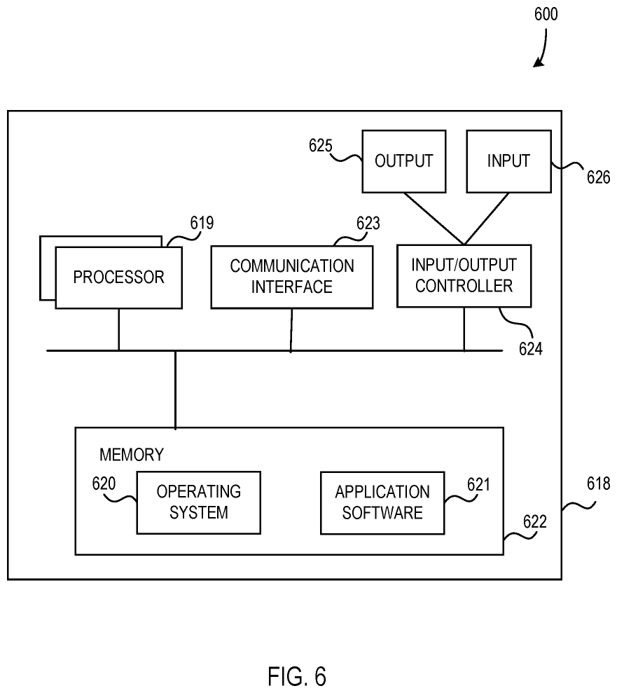

The present disclosure is operable with a computing apparatus according to an embodiment as a functional block diagram 600 in FIG. 6. In an embodiment, components of a computing apparatus 618 may be implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. Platform software comprising an operating system 620 or any other suitable platform software may be provided on the apparatus 618 to enable application software 621 to be executed on the device. According to an embodiment, classifying collaboration ties of users in a user network and generating recommended actions based on those classifications as described herein may be accomplished by software, hardware, and/or firmware.

Computer executable instructions may be provided using any computer-readable media that are accessible by the computing apparatus 618. Computer-readable media may include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that the storage may be distributed or located remotely and accessed via a network or other communication link (e.g. using a communication interface 623).

The computing apparatus 618 may comprise an input/output controller 624 configured to output information to one or more output devices 625, for example a display or a speaker, which may be separate from or integral to the electronic device. The input/output controller 624 may also be configured to receive and process an input from one or more input devices 626, for example, a keyboard, a microphone, or a touchpad. In one embodiment, the output device 625 may also act as the input device. An example of such a device may be a touch sensitive display. The input/output controller 624 may also output data to devices other than the output device, e.g. a locally connected printing device. In some embodiments, a user may provide input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for improving collaboration between users in a user network based on collaboration strength and collaboration diversity comprises: at least one processor; and at least one memory comprising computer program code, the at least one memory and the computer program code configured to, with the at least one processor, cause the at least one processor to: collect collaboration data associated collaboration activity between a plurality of user accounts in the user network; identify collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as a source user account to a second user account of the pair as a target user account is identified and a second collaboration tie from the second user account as source user account to the first user account as a target user account is identified; determine, for each identified collaboration tie, a tie strength score based on the collected collaboration data; determine, for each identified collaboration tie, a tie diversity score based on the collected collaboration data; classify each collaboration tie in a strong tie classification or a weak tie classification based on the determined tie strength score and a defined tie strength threshold; classify each collaboration tie in a diverse tie classification or a nondiverse tie classification based on the determined tie diversity score and a defined tie diversity threshold; generate a recommended action based on analysis of the classifications of the collaboration ties, wherein the recommended action is directed toward at least one of increasing diversity of collaboration or strengthening collaboration of at least one user account of the plurality of user accounts of the user network; and provide the generated recommended action via a collaboration interface, whereby the collaboration interface enables collaboration strength or collaboration diversity of the user network to be improved.

An example computerized method for improving collaboration between users in a user network based on collaboration strength and collaboration diversity comprises: collecting, by a processor, collaboration data associated collaboration activity between a plurality of user accounts in the user network; identifying, by the processor, collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as a source user account to a second user account of the pair as a target user account is identified and a second collaboration tie from the second user account as source user account to the first user account as a target user account is identified; determining, by the processor, for each identified collaboration tie, a tie strength score based on the collected collaboration data; determining, by the processor, for each identified collaboration tie, a tie diversity score based on the collected collaboration data; classifying, by the processor, each collaboration tie in a strong tie classification or a weak tie classification based on the determined tie strength score and a defined tie strength threshold; classifying, by the processor, each collaboration tie in a diverse tie classification or a nondiverse tie classification based on the determined tie diversity score and a defined tie diversity threshold; generating, by the processor, a recommended action based on analysis of the classifications of the collaboration ties, wherein the recommended action is directed toward at least one of increasing diversity of collaboration or strengthening collaboration of at least one user account of the plurality of user accounts of the user network; and providing, by the processor, the generated recommended action via a collaboration interface, whereby the collaboration interface enables collaboration strength or collaboration diversity of the user network to be improved.

One or more non-transitory computer storage media having computer-executable instructions for improving collaboration between users in a user network based on collaboration strength and collaboration diversity that, upon execution by a processor, causes the processor to at least: collect collaboration data associated collaboration activity between a plurality of user accounts in the user network; identify collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as a source user account to a second user account of the pair as a target user account is identified and a second collaboration tie from the second user account as source user account to the first user account as a target user account is identified; determine, for each identified collaboration tie, a tie strength score based on the collected collaboration data; determine, for each identified collaboration tie, a tie diversity score based on the collected collaboration data; classify each collaboration tie in a strong tie classification or a weak tie classification based on the determined tie strength score and a defined tie strength threshold; classify each collaboration tie in a diverse tie classification or a nondiverse tie classification based on the determined tie diversity score and a defined tie diversity threshold; generate a recommended action based on analysis of the classifications of the collaboration ties, wherein the recommended action is directed toward at least one of increasing diversity of collaboration or strengthening collaboration of at least one user account of the plurality of user accounts of the user network; and provide the generated recommended action via a collaboration interface, whereby the collaboration interface enables collaboration strength or collaboration diversity of the user network to be improved.

Alternatively, or in addition to the other examples described herein, examples include any combination of the following:
wherein the determined tie strength score of a collaboration tie of a source user account and a target user account is based on a combination of collaboration data associated with collaboration activity between the source user account and the target user account, collaboration data associated with collaboration activity between the source user account and a common set of user accounts with which the source user account and target user account have collaboration ties, and collaboration data associated with collaboration activity between the target user account and the common set of user accounts.
wherein the determined tie diversity score of a collaboration tie of a source user account and a target user account is based on collaboration data associated with collaboration activity between the target user account and a set of user accounts with which the source user account lacks collaboration ties.
wherein the determined tie strength score and the determined tie diversity score are based on collaboration data indicating at least one of the following: type of collaboration, duration of collaboration, quantity of collaboration instances, and timing of collaboration.
wherein the collaboration data is based on collaborations via at least one of the following: email collaboration, meeting collaboration, phone call collaboration, video chat collaboration, electronic messaging collaboration, and shared document collaboration.
further comprising: generating, by the processor, collaboration characteristics of the user network based on the classified collaboration ties, wherein the collaboration characteristics include characteristics associated with at least one of the following: network stability, manager effectiveness, top performer identification, dormant collaboration tie identification, team efficiency, team innovation, and mentor network identification; wherein providing the generated recommended action via the collaboration interface includes providing the generated collaboration characteristics via the collaboration interface in combination with the generated recommended action.
wherein the defined tie strength threshold and the defined tie diversity threshold are determined, for each collaboration tie being classified, based on at least one of the following: a role of a source user account of the collaboration tie, a role of a target user account of the collaboration tie, a team with which the source user account of the collaboration tie is associated, and a team which the target user account of the collaboration tie is associated.
wherein the defined tie strength threshold and the defined tie diversity threshold are determined using a trained model, wherein the trained model is configured to learn to define the tie strength threshold and the tie diversity threshold using a set of collaboration data from the user network and an associated set of tie strength scores and tie diversity scores.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for collecting, by a processor, collaboration data associated collaboration activity between a plurality of user accounts in the user network; exemplary means for identifying, by the processor, collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as a source user account to a second user account of the pair as a target user account is identified and a second collaboration tie from the second user account as source user account to the first user account as a target user account is identified; exemplary means for determining, by the processor, for each identified collaboration tie, a tie strength score based on the collected collaboration data; exemplary means for determining, by the processor, for each identified collaboration tie, a tie diversity score based on the collected collaboration data; exemplary means for classifying, by the processor, each collaboration tie in a strong tie classification or a weak tie classification based on the determined tie strength score and a defined tie strength threshold; exemplary means for classifying, by the processor, each collaboration tie in a diverse tie classification or a nondiverse tie classification based on the determined tie diversity score and a defined tie diversity threshold; exemplary means for generating, by the processor, a recommended action based on analysis of the classifications of the collaboration ties, wherein the recommended action is directed toward at least one of increasing diversity of collaboration or strengthening collaboration of at least one user account of the plurality of user accounts of the user network; and exemplary means for providing, by the processor, the generated recommended action via a collaboration interface, whereby the collaboration interface enables collaboration strength or collaboration diversity of the user network to be improved.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for improving collaboration between user accounts in a user network based on collaboration strength and collaboration diversity, the system comprising:
at least one processor; and
at least one memory comprising computer program code, the at least one memory and the computer program code configured to, with the at least one processor, cause the at least one processor to:
collect collaboration data associated with collaboration activity between a plurality of user accounts in the user network;
identify collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as the source user account to a second user account of the pair as the target user account is identified and a second collaboration tie from the second user account as the source user account to the first user account as the target user account is identified;
determine, for each identified collaboration tie, a tie strength score based on the collected collaboration data;
determine, for each identified collaboration tie, a tie diversity score based on the collected collaboration data;
classify each identified collaboration tie in a strong tie classification or a weak tie classification based on the determined tie strength score and a defined tie strength threshold;
classify each identified collaboration tie in a diverse tie classification or a nondiverse tie classification based on the determined tie diversity score and a defined tie diversity threshold;
generate a recommended action based on analysis of the classified collaboration ties, wherein the recommended action is directed toward at least one of increasing diversity of collaboration or strengthening collaboration of at least one user account of the plurality of user accounts of the user network; and
provide the generated recommended action via a collaboration interface, whereby the collaboration interface enables collaboration strength or collaboration diversity of the user network to be improved.

2. The system of claim 1, wherein the determined tie strength score of a collaboration tie of the source user account and the target user account is based on a combination of collaboration data associated with collaboration activity between the source user account and the target user account, collaboration data associated with collaboration activity between the source user account and a common set of user accounts with which the source user account and the target user account have collaboration ties, and collaboration data associated with collaboration activity between the target user account and the common set of user accounts.

3. The system of claim 1, wherein the determined tie diversity score of a collaboration tie of the source user account and the target user account is based on collaboration data associated with collaboration activity between the target user account and a set of user accounts with which the source user account lacks collaboration ties.

4. The system of claim 1, wherein the determined tie strength score and the determined tie diversity score are based on collaboration data indicating at least one of the following: type of collaboration, duration of collaboration, quantity of collaboration instances, and timing of collaboration.

5. The system of claim 1, wherein the collaboration data is based on collaborations via at least one of the following: email collaboration, meeting collaboration, phone call collaboration, video chat collaboration, electronic messaging collaboration, and shared document collaboration.

6. The system of claim 1, wherein the at least one memory and the computer program code is configured to, with the at least one processor, further cause the at least one processor to:
generate collaboration characteristics of the user network based on the classified collaboration ties, wherein the collaboration characteristics include characteristics associated with at least one of the following: network stability, manager effectiveness, top performer identification, dormant collaboration tie identification, team efficiency, team innovation, and mentor network identification; and
wherein providing the generated recommended action via the collaboration interface includes providing the generated collaboration characteristics via the collaboration interface in combination with the generated recommended action.

7. The system of claim 1, wherein the defined tie strength threshold and the defined tie diversity threshold are determined, for each collaboration tie being classified, based on at least one of the following: a role of the source user account of the collaboration tie, a role of the target user account of the collaboration tie, a team with which the source user account of the collaboration tie is associated, and a team which the target user account of the collaboration tie is associated.

8. The system of claim 1, wherein the defined tie strength threshold and the defined tie diversity threshold are determined using a trained model, wherein the trained model is configured to learn to define the tie strength threshold and the tie diversity threshold using a set of collaboration data from the user network and an associated set of tie strength scores and tie diversity scores.

9. A computerized method for improving collaboration between users in a user network based on collaboration strength and collaboration diversity, the computerized method comprising:
collecting, by a processor, collaboration data associated with collaboration activity between a plurality of user accounts in the user network;
identifying, by the processor, collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as the source user account to a second user account of the pair as the target user account is identified and a second collaboration tie from the second user account as the source user account to the first user account as the target user account is identified;
determining, by the processor, for each identified collaboration tie, a tie strength score based on the collected collaboration data;
determining, by the processor, for each identified collaboration tie, a tie diversity score based on the collected collaboration data;
classifying, by the processor, each identified collaboration tie in a strong tie classification or a weak tie classification based on the determined tie strength score and a defined tie strength threshold;
classifying, by the processor, each identified collaboration tie in a diverse tie classification or a nondiverse tie classification based on the determined tie diversity score and a defined tie diversity threshold;
generating, by the processor, a recommended action based on analysis of the classified collaboration ties, wherein the recommended action is directed toward at least one of increasing diversity of collaboration or strengthening collaboration of at least one user account of the plurality of user accounts of the user network; and
providing, by the processor, the generated recommended action via a collaboration interface, whereby the collaboration interface enables collaboration strength or collaboration diversity of the user network to be improved.

10. The computerized method of claim 9, wherein the determined tie strength score of a collaboration tie of the source user account and the target user account is based on a combination of collaboration data associated with collaboration activity between the source user account and the target user account, collaboration data associated with collaboration activity between the source user account and a common set of user accounts with which the source user account and the target user account have collaboration ties, and collaboration data associated with collaboration activity between the target user account and the common set of user accounts.

11. The computerized method of claim 9, wherein the determined tie diversity score of a collaboration tie of the source user account and the target user account is based on collaboration data associated with collaboration activity between the target user account and a set of user accounts with which the source user account lacks collaboration ties.

12. The computerized method of claim 9, wherein the determined tie strength score and the determined tie diversity score are based on collaboration data indicating at least one of the following: type of collaboration, duration of collaboration, quantity of collaboration instances, and timing of collaboration.

13. The computerized method of claim 9, wherein the collaboration data is based on collaborations via at least one of the following: email collaboration, meeting collaboration, phone call collaboration, video chat collaboration, electronic messaging collaboration, and shared document collaboration.

14. The computerized method of claim 9, further comprising:
generating, by the processor, collaboration characteristics of the user network based on the classified collaboration ties, wherein the collaboration characteristics include characteristics associated with at least one of the following: network stability, manager effectiveness, top performer identification, dormant collaboration tie identification, team efficiency, team innovation, and mentor network identification; and
wherein providing the generated recommended action via the collaboration interface includes providing the generated collaboration characteristics via the collaboration interface in combination with the generated recommended action.

15. The computerized method of claim 9, wherein the defined tie strength threshold and the defined tie diversity threshold are determined, for each collaboration tie being classified, based on at least one of the following: a role of the source user account of the collaboration tie, a role of the target user account of the collaboration tie, a team with which the source user account of the collaboration tie is associated, and a team which the target user account of the collaboration tie is associated.

16. The computerized method of claim 9, wherein the defined tie strength threshold and the defined tie diversity threshold are determined using a trained model, wherein the trained model is configured to learn to define the tie strength threshold and the tie diversity threshold using a set of collaboration data from the user network and an associated set of tie strength scores and tie diversity scores.

17. One or more non-transitory computer storage media having computer-executable instructions for improving collaboration between users in a user network based on collaboration strength and collaboration diversity that, upon execution by a processor, cause the processor to at least:
collect collaboration data associated with collaboration activity between a plurality of user accounts in the user network;
identify collaboration ties of the plurality of user accounts in the user network based on the collected collaboration data, wherein each collaboration tie is associated with a source user account and a target user account and, for each pair of user accounts between which collaboration ties are identified, a first collaboration tie from a first user account of the pair as the source user account to a second user account of the pair as the target user account is identified and a second collaboration tie from the second user account as the source user account to the first user account as the target user account is identified;
determine, for each identified collaboration tie, a tie strength score based on the collected collaboration data;
determine, for each identified collaboration tie, a tie diversity score based on the collected collaboration data;
classify each identified collaboration tie in a strong tie classification or a weak tie classification based on the determined tie strength score and a defined tie strength threshold;
classify each identified collaboration tie in a diverse tie classification or a nondiverse tie classification based on the determined tie diversity score and a defined tie diversity threshold;
generate a recommended action based on analysis of the classified collaboration ties, wherein the recommended action is directed toward at least one of increasing diversity of collaboration or strengthening collaboration of at least one user account of the plurality of user accounts of the user network; and
provide the generated recommended action via a collaboration interface, whereby the collaboration interface enables collaboration strength or collaboration diversity of the user network to be improved.

18. The one or more non-transitory computer storage media of claim 17, wherein the determined tie strength score of a collaboration tie of the source user account and the target user account is based on a combination of collaboration data associated with collaboration activity between the source user account and the target user account, collaboration data associated with collaboration activity between the source user account and a common set of user accounts with which the source user account and the target user account have collaboration ties, and collaboration data associated with collaboration activity between the target user account and the common set of user accounts.

19. The one or more non-transitory computer storage media of claim 17, wherein the determined tie diversity score of a collaboration tie of the source user account and the target user account is based on collaboration data associated with collaboration activity between the target user account and a set of user accounts with which the source user account lacks collaboration ties.

20. The one or more non-transitory computer storage media of claim 17, wherein the determined tie strength score and the determined tie diversity score are based on collaboration data indicating at least one of the following: type of collaboration, duration of collaboration, quantity of collaboration instances, and timing of collaboration.
